(19) United States
(12) Patent Application Publication
(10) Pub. No.: US 2014/0124276 A1
(43) Pub. Date: May 8, 2014

(54) Dual Rotor Electric Drive

(71) Applicant: CATERPILLAR, INC., Peoria, IL (US)

(72) Inventors: Krishnakumar Ramamoorthy, Peoria, IL (US); Sami Alkhouli, Peoria, IL (US)

(73) Assignee: CATERPILLAR, INC., Peoria, IL (US)

(21) Appl. No.: 13/672,275

(22) Filed: Nov. 8, 2012

(51) Int. Cl. B60K 6/46; H02K 49/04; B62D 55/00; H02K 16/02

(52) U.S. Cl. CPC B60K 6/46; H02K 16/02; H02K 49/043; B62D 55/00; Y10S 903/903
USPC 180/9; 310/114; 310/105; 180/65.245; 903/903

(57) ABSTRACT

A series electric drive includes a cylindrical first rotor with a number of permanent magnets therein and an input linked to the cylindrical first rotor. The series electric drive further includes a cylindrical second rotor stacked radially within the cylindrical first rotor, the cylindrical second rotor being a wound rotor, and an output being linked to the cylindrical second rotor. A cylindrical stator is stacked axially relative to the first rotor, and a portion of the second rotor is stacked radially within the cylindrical stator, the cylindrical stator being a wound stator.

### TECHNICAL FIELD OF THE DISCLOSURE

The present disclosure relates to electric drive for machines and, more particularly, relates to a system and method for providing a dual rotor electric drive in a hybrid machine.

### BACKGROUND OF THE DISCLOSURE

During the use of machines powered by internal combustion engines, fuel is consumed and pollution may be generated roughly in proportion to the amount of fuel consumed. Moreover, depending upon whether the internal combustion engine is operated at its peak efficiency configuration, the use of internal combustion engines entails varying degrees of inefficiency in the conversion of fuel to power.

One way to reduce the fuel usage and increase the efficiency of machines that utilize internal combustion engine power is to provide a hybrid drive system wherein the internal combustion engine provides power that is converted to electric power and used to electrically drive the machine. An example of this is U.S. Pat. No. 8,240,412 to Andri. This patent shows a fairly typical drive system wherein an electric motor is coupled to an electrical generator. The generator can receive power from the motor for storage or can provide power to the motor for traction. However, such systems still involve a certain amount of inefficiency in power transfer and conversion between the two separate motor and generator entities.

The present disclosure is directed to systems and methods that address one or more of the problems set forth above. However, it should be appreciated that the solution of any particular problem is not a limitation on the scope of this disclosure or of the attached claims except to the extent expressly noted. Additionally, the inclusion of any problem or solution in this Background section is not an indication that the problem or solution represents known prior art except as otherwise expressly noted.

### SUMMARY OF THE DISCLOSURE

In accordance with one aspect of the present disclosure, a series electric drive is provided having a cylindrical first rotor with a number of permanent magnets therein and an input linked to the cylindrical first rotor. The machine further includes a cylindrical second rotor stacked radially within the cylindrical first rotor, the cylindrical second rotor being a wound rotor, and an output being linked to the cylindrical second rotor. A cylindrical stator is stacked axially relative to the first rotor, and a portion of the second rotor is stacked radially within the cylindrical stator, the cylindrical stator being a wound stator.

In accordance with another aspect of the present disclosure, a machine is provided having a series electric drive. The machine includes an internal combustion engine and a dual rotor electric machine receiving rotational power from the internal combustion engine. The dual rotor electric machine includes a first rotor axially stacked with a stator and a second rotor concentric with and radially stacked within both the first rotor and the stator, wherein the second rotor provides an output The machine also includes a load linked to the output.

In accordance with yet another aspect of the present disclosure, an electric machine is provided including a permanent magnet rotor and a wound rotor coupled to the permanent magnet rotor to induce a current in the wound rotor during relative movement of the permanent magnet rotor and the wound rotor. The machine also includes a fixed wound stator surrounding the wound rotor to impart a torque thereto when a current is induced in the wound rotor.

Other features and advantages of the disclosed systems and principles will become apparent from reading the following detailed disclosure in conjunction with the included drawing figures.

### BRIEF DESCRIPTION OF THE DRAWINGS

FIG. 1 is a schematic diagram of a hybrid power train system in accordance with an aspect of the disclosed principles;

FIG. 2 is a schematic cross-sectional side view of a dual rotor electric machine in accordance with an embodiment of the disclosure;

FIG. 3 is a schematic cross-sectional end view of the dual rotor electric machine according to FIG. 2 in an embodiment of the disclosure;

FIG. 4 is another schematic cross-sectional end view of the dual rotor electric machine according to FIG. 2 in an embodiment of the disclosure.

FIG. 5 is a power flow chart for a dual rotor electric machine driven power train in accordance with an embodiment of the disclosure; and

FIG. 6 is a torque/phase diagram for a dual rotor electric machine in accordance with an embodiment of the disclosure.

### DETAILED DESCRIPTION OF THE DISCLOSURE

The present disclosure provides a system and method for providing a hybrid power train for a machine. The hybrid power train utilizes a dual rotor electric machine to convert rotational engine energy into a rotational output with no direct mechanical connection between the engine and the output. In an embodiment, the dual rotor electric machine employs a first rotor and a stator, stacked axially. A second rotor is stacked radially within the first rotor and the stator, such that rotation of the first rotor induces currents in the second rotor, and the induced currents then interact with the stator to produce a torque in the second rotor.

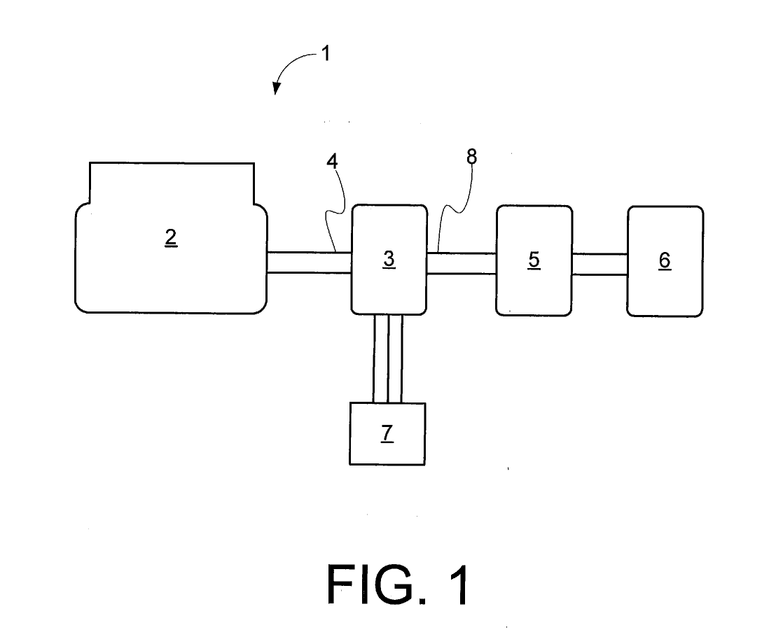

Turning to the figures, FIG. 1 is a schematic overview diagram of a hybrid drive system in accordance with an embodiment of the disclosure. The illustrated hybrid drive system 1 includes an internal combustion engine 2 coupled to a dual rotor electric machine 3. The input 4 of the dual rotor electric machine is coupled to the internal combustion engine 2, while the output 8 of the dual rotor electric machine 3 is coupled, potentially through a transmission 5, to one or more traction devices 6. It will be appreciated that the one or more traction devices 6 may include one or more tracks, one or more wheels, and so on.

A power controller 7 is included in the illustrated hybrid drive system 1 in accordance with an embodiment of the disclosure, and is interfaced to the dual rotor electric machine 3. In this way, the power controller 7 is able to control the conversion of power from the internal combustion engine 2 to the dual rotor electric machine 3. In an embodiment of the disclosure, the power controller 7 operates by variably energizing a stator of the dual rotor electric machine 3 to control power transfer to a rotor of the dual rotor electric machine 3.

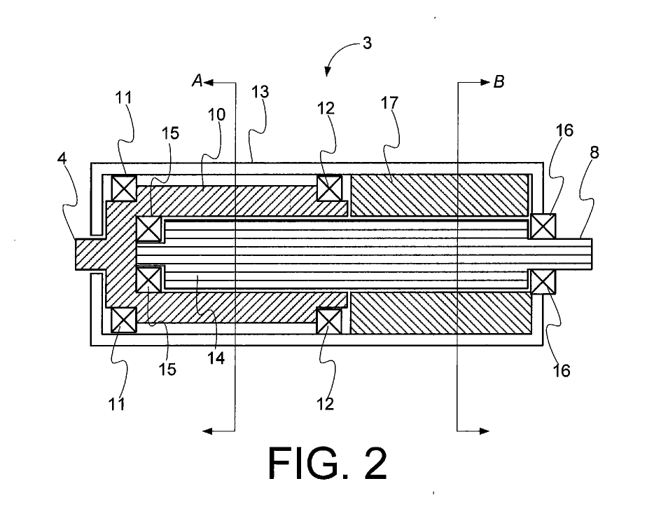

In keeping with this embodiment of the disclosure, FIG. 2 is a schematic cross-section of a dual rotor electric machine 3 in accordance with an embodiment. The illustrated dual rotor electric machine 3 includes an input 4 and an output 8. The input 4 is attached to a cylindrical first rotor 10. The cylindrical first rotor 10 is a permanent magnet rotor in an embodiment of the disclosure, and may be supported relative to a machine case 13 by a first bearing set 11 and a second bearing set 12 in keeping with the illustrated example.

The cylindrical first rotor 10 is cylindrical in nature and surrounds a cylindrical second rotor 14. The cylindrical second rotor 14 may be supported in keeping with the illustrated example by a third bearing set 15 relative to the cylindrical first rotor 10. In addition, the cylindrical second rotor 14 may be supported in keeping with the illustrated example by a fourth bearing set 16 relative to the machine case 13.

In the illustrated example, the cylindrical second rotor 14 extends beyond the cylindrical first rotor 10, such that between an end of the cylindrical first rotor 10 and the fourth bearing set 16, the cylindrical second rotor 14 extends through a cylindrical stator 17. The cylindrical stator 17 is fixed to the machine case 13 to facilitate the transfer of torque between the cylindrical stator 17 and the cylindrical second rotor 14.

In an embodiment, as noted above, the cylindrical first rotor 10 is a permanent magnet rotor. In this embodiment, the cylindrical stator 17 is a three-phase wound stator and the cylindrical second rotor is a three-phase wound rotor having the end of each winding shorted to the same end of each adjacent winding.

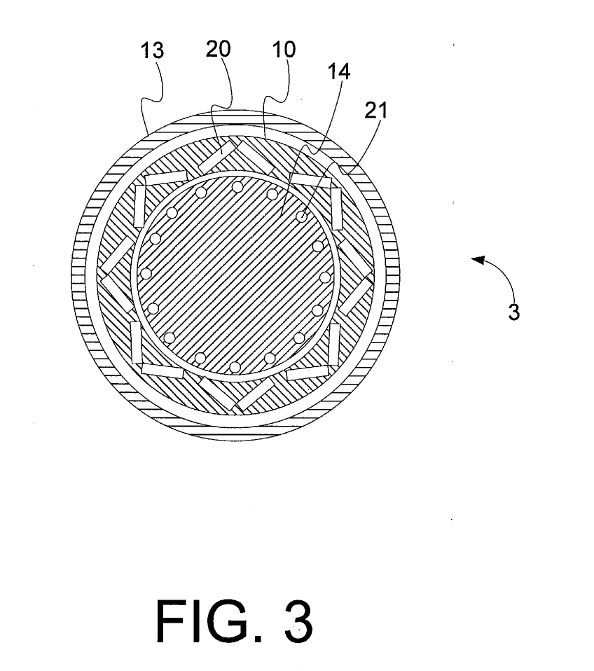

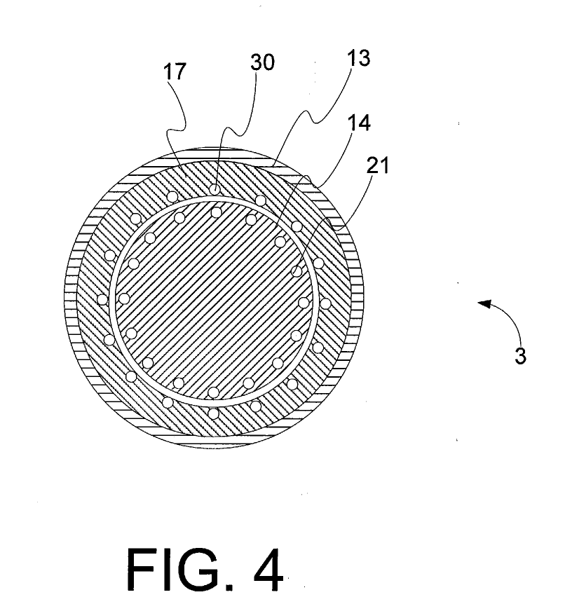

The construction and configuration of the cylindrical first rotor 10, cylindrical second rotor 14, and cylindrical stator 17 may be better appreciated from reviewing FIGS. 3 and 4. FIG. 3 is a schematic cross section of the dual rotor electric machine 3 of FIG. 2 taken at line A. As can be seen, the machine case 13 surrounds the cylindrical first rotor 10, which in turn surrounds the cylindrical second rotor 14.

The cylindrical first rotor 10 is a permanent magnet rotor in this embodiment as noted above. As such, the cylindrical first rotor 10 includes a plurality of permanent magnets 20 arranged circumferentially to apply a circumferentially varying magnetic field to the cylindrical second rotor 14.

The cylindrical second rotor 14 includes a plurality of rotor conductors 21 comprising windings as discussed above. The rotor conductors 21 are illustrated at a large scale for visibility, but in practice the rotor conductors 21 may include a much larger number of much smaller conductors. As noted above, although it cannot be seen in the view of FIG. 2, the rotor conductors 21 form a three phase winding with each end of each winding shorted to the adjacent ends of the adjacent windings.

The interaction between the cylindrical second rotor 14 and the cylindrical stator 17 may be better appreciated from FIG. 4, which is a schematic end view of the dual rotor electric machine 3 of FIG. 2 taken at the line B. The illustrated example of FIG. 4 shows the machine case 13 affixed to the cylindrical stator 17. The cylindrical stator 17 in turn surrounds the cylindrical second rotor 14. As was discussed above with respect to FIG. 3, the cylindrical second rotor 14 includes a plurality of rotor conductors 21 comprising windings, and in an embodiment forming a three phase winding with each end of each winding shorted to the adjacent ends of the adjacent windings.

The cylindrical stator 17 also comprises a plurality of stator windings 30 wound as a three phase winding. Though not shown in FIG. 4, the three phases of the plurality of stator windings 30 are brought out and exposed to facilitate control of the currents in the plurality of stator windings 30 and thus in the plurality of rotor conductors 21 of the cylindrical second rotor 14.

In operation, the internal combustion engine 2 turns the cylindrical first rotor 10 at a speed matching the engine speed or geared upward or downward from the engine speed as desired. In an embodiment, the gearing between the internal combustion engine 2 and the cylindrical first rotor 10 may be shiftable to encompass different ratios. In an alternative embodiment, the internal combustion engine directly drives the cylindrical first rotor 10.

As the cylindrical first rotor 10 spins, the permanent magnets thereof generate an electric current in the windings of the cylindrical second rotor 14. Because the currents travel in loops defined by the windings of the second cylindrical rotor, the induced currents also appear in the portion of the second cylindrical rotor that extends into the cylindrical stator 17. The currents in this manner interact with currents in the windings of the cylindrical stator 17, which are controlled via a power controller external to the electric machine.

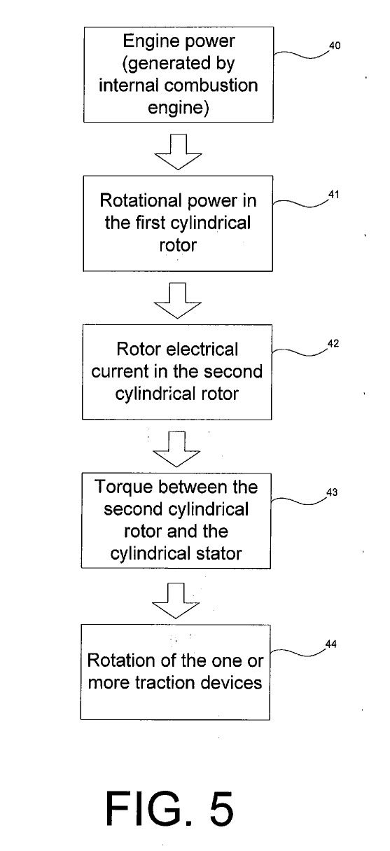

Turning to FIG. 5, this figure shows the power transfer within the overall system in accordance with an embodiment of the disclosure. The power in the system originates with the engine power 40 generated by the internal combustion engine. The engine power 40 is in turn converted into rotational power 41 in the first cylindrical rotor 10. As noted above, the torque and speed of conversion may be adapted to a given implementation.

Since the first cylindrical rotor 10 surround the second cylindrical rotor 14, the rotational power 41 in the first cylindrical rotor 10 in converted into rotor electrical current 42 in the second cylindrical rotor. While the mere circulation of electrical current requires very little power in the abstract, in the illustrated configuration, the inductance of other elements will increase the power density in the first cylindrical rotor.

In particular, the rotor electrical current 42 in the second cylindrical rotor 14 interacts with the current in the windings of the cylindrical stator 17. This interaction produces a torque 43 between the second cylindrical rotor 14 and the cylindrical stator 17. This produced torque is in turn used to produce rotation 44 of the one or more traction devices 6, potentially via an intervening transmission.

As noted above, the current in the windings of the cylindrical stator 17 can be used to control the transfer of torque from the cylindrical stator 17 to the second cylindrical rotor. In particular, in an embodiment of the disclosure, the relative phase of the currents is used to control the torque transfer. In an embodiment, when the current in the cylindrical stator 17 is of opposite phase with the current in the second cylindrical rotor 14, the torque transfer is at a minimum, e.g., at zero. Similarly, when the current in the cylindrical stator 17 is at a 90° phase to the current in the second cylindrical rotor 14, the torque transfer is at a maximum.

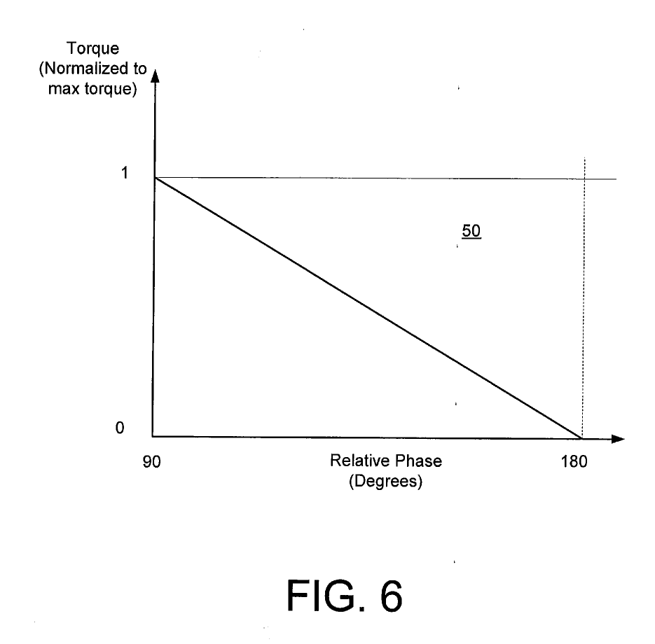

FIG. 6 shows the relationship in an embodiment between the relative phase of the current in the cylindrical stator and the current in the second cylindrical rotor. As can be seen from the phase/torque plot 50, with the relative phase between the currents at 180 degrees, the torque transfer is zero. As the relative phase between the currents decreases, the torque transfer increases, reaching a maximum when the relative phases are at 90 degrees. It will be appreciated that the phase behavior of the system is periodic, and thus repeats as phase is continually changed.

### INDUSTRIAL APPLICABILITY

In general terms, the present disclosure sets forth a system and method applicable to machines and systems that employ internal combustion engines for motive power, especially though not exclusively with respect to track-type and wheel powered machines. In an embodiment, a hybrid power system is provided that converts the rotational energy of an internal combustion engine into a variable rotational speed and torque output. A single machine provides this conversion through the use of dual rotors. The first rotor, turned by the internal combustion engine, is a permanent magnet rotor that generates a current in the windings of an enclosed second rotor.

The second rotor extends from within the first rotor to within an adjacent wound stator. The currents in the second rotor thus interact with currents in the windings of the wound stator to induce a torque between the second rotor and the wound stator. It is this induced torque that is in turn used to propel the machine.

While only certain embodiments have been set forth herein, alternatives and modifications will be apparent from the above description to those of skill in the art. These and other alternatives are considered equivalents and within the spirit and scope of this disclosure and the appended claims.

What is claimed is:

1. A series electric drive comprising:
a cylindrical first rotor having a plurality of permanent magnets therein;
an input linked to the cylindrical first rotor;
a cylindrical second rotor stacked radially within the cylindrical first rotor, the cylindrical second rotor being a wound rotor;
an output linked to the cylindrical second rotor;
a cylindrical stator stacked axially relative to the first rotor, a portion of the second rotor being stacked radially within the cylindrical stator, the cylindrical stator being a wound stator.

2. The series electric drive according to claim 1, further comprising an internal combustion engine linked to the input.

3. The series electric drive according to claim 1, further comprising a load linked to the output.

4. The series electric drive according to claim 3, wherein the load includes one or more traction devices.

5. The series electric drive according to claim 1, further comprising a power controller for controlling a torque between the cylindrical stator and the cylindrical second rotor.

6. The series electric drive according to claim 5, wherein the power controller is adapted to control the torque between the cylindrical stator and the cylindrical second rotor by controlling a phase of a current in the cylindrical stator relative to a current in the cylindrical second rotor.

7. The series electric drive according to claim 1, wherein the cylindrical stator and the cylindrical second rotor are each wound with three phase windings.

8. A machine having a series electric drive, the machine comprising:
an internal combustion engine;
a dual rotor electric machine receiving rotational power from the internal combustion engine, the dual rotor electric machine comprising:
a first rotor axially stacked with a stator; and
a second rotor concentric with and radially stacked within both the first rotor and the stator, wherein the second rotor provides an output; and
a load linked to the output.

9. The machine having a series electric drive according to claim 8, wherein the first rotor, second rotor, and stator are freely rotatable with respect to one another.

10. The machine having a series electric drive according to claim 8, further including a power controller for controlling a torque between the second rotor and the stator.

11. The machine having a series electric drive according to claim 10, wherein the power controller is adapted to control the torque between the second rotor and the stator by controlling the relative phase of a current in the second rotor and a current in the stator.

12. The machine having a series electric drive according to claim 11, wherein the power controller is adapted to control the relative phase of the current in the second rotor and the current in the stator by controlling the current in the stator.

13. The machine having a series electric drive according to claim 12, wherein the current in the second rotor and the current in the stator are three phase currents.

14. The machine having a series electric drive according to claim 8, wherein the load linked to the output comprises one or more traction devices to provide motive power.

15. The machine having a series electric drive according to claim 14, wherein the one or more traction devices include one or more tracks.

16. The machine having a series electric drive according to claim 14, wherein the one or more traction devices include one or more wheels.

17. The machine having a series electric drive according to claim 14, further comprising a transmission between the output and the one or more traction devices.

18. An electric machine comprising:
a permanent magnet rotor;
a wound rotor coupled to the permanent magnet rotor to induce a current in the wound rotor during relative movement of the permanent magnet rotor and the wound rotor; and
a fixed wound stator surrounding the wound rotor to impart a torque thereto when a current is induced in the wound rotor.

19. The electric machine according to claim 18, wherein the wound rotor and the wound stator are wound with three phase windings.

20. The electric machine according to claim 18, wherein the permanent magnet rotor is concentric with and at least partially encloses the wound rotor.
